(19) United States
(12) Patent Application Publication
(10) Pub. No.: US 2002/0138338 A1
(43) Pub. Date: Sep. 26, 2002

(54) Customer complaint alert system and method

(76) Inventors: Gregory L. Trauth, Covington, KY (US); Clinton D. Brown, Crestview Hills, KY (US); Daniel S. Argo, Taylor Mill, KY (US)

Correspondence Address: S.Z. Szczepanski, Jenkens & Gilchrist, Suite 2600, 225 West Washington Street, Chicago, IL, 60606-3418, US

(21) Appl. No.: 09/998,941

(22) Filed: Nov. 15, 2001

Related U.S. Application Data
(60) Provisional application No. 60/278,220, filed on Mar. 23, 2001.

(51) Int. Cl. G06F 17/60

(52) U.S. Cl. 705/10

(57) ABSTRACT

A system and method for notifying customer service personnel of customer feedback messages. When a feedback message is received from a customer, an electronic notification message or “alert” message is transmitted to customer service personnel indicating receipt of the message. The system may record spoken feedback messages from customers which are stored in audio files. Customer service personnel may then call into the system to listen to the audio file. Alternatively, the audio file is attached to the alert message. An additional embodiment enables records related to received customer feedback messages to be displayed and tracked using a web site.

### CROSS-REFERENCE TO RELATED APPLICATIONS

This application claims the benefit of priority from United States Provisional Application Serial No. 60/278,220, filed Mar. 23, 2001 entitled “Customer Complaint Alert System And Method.”

### FIELD OF THE INVENTION

The present invention relates to the field of monitoring customer complaints. More specifically, the present invention relates to an electronic system and method for notifying companies and retailers of customer complaints or dissatisfaction responses to survey questions and monitoring the resolution of these responses.

### BACKGROUND OF THE INVENTION

Customer satisfaction and attitude research surveys are common. Most surveys receive customer feedback by requiring a customer to provide either written responses to a survey questionnaire or require the customer to orally respond to questions asked during a telephonic survey. Questionnaires or surveys requiring written responses must be sent to a central location where the responses must be read, transcribed, sorted, and manually forwarded to the relevant company. Therefore, a great deal of time elapses before a company becomes aware of any complaints or dissatisfaction identified by the customer.

The same problems arise with responses received during telephonic surveys. If the customer's responses to survey questions are recorded by an employee, then these records must be read, sorted and manually forwarded to the relevant company just as if the customer had responded to a written questionnaire. Alternatively, a telephonic survey may be conducted where the responses received by the customer are electronically recorded. The recorded responses must then be transcribed and analyzed in order to be sent to the appropriate company. Again, these methods generate a substantial lag time between when the customer's complaint or dissatisfaction is originally filed and when the company's manager or customer service representatives receive actual notice of the complaint. This apparent non-responsiveness by the company degrades the good-will of the related business (i.e., a retailer) with its customers.

One possible method for increasing the response time is to send the customer complaints via facsimile to the manager of the store which is the subject of the complaint. This method does not completely resolve the problem since a considerable delay may still exist before the manager or responsible customer service personnel actually receive the facsimile message. Further, it is very difficult to track when the facsimile message is actually received by the appropriate personnel and remedial action taken.

Therefore, a need exists for a system and method that provides a nearly immediate notification of customer complaints to the appropriate company employees.

Additionally, a need exists for a system and method enabling management personnel to easily track the complaints received by consumers and also track the progress of the resolution of each complaint.

It is therefore an object of an embodiment of the present invention to provide real-time notification to company employees of customer complaints.

It is also an object of an embodiment of the present invention to allow customers to provide verbal feedback in response to customer survey questions and to make this verbal feedback immediately available for company employees.

Another object of an embodiment of the present invention is to allow company employees to easily track the occurrence and resolution of customer complaints through a web-based system.

### SUMMARY OF THE INVENTION

An embodiment of the present invention provides an electronic system and method for generating an electronic notification or “alert” message when a customer feedback message, such as a complaint, is received. This message is then sent to a company representative, such as a customer service employee, responsible for handling the message. The electronic notification indicates that a customer feedback message has been received.

Another embodiment allows a customer to record an audio message containing the customer's message. After receiving the electronic notification message, the company representative may then access the system to listen to the customer's message. Alternatively, the recorded customer message may be attached to the electronic notification transmitted to the company representative.

Another embodiment of the present invention provides a database which logs and monitors all customer feedback messages received for a company. A web site is accessible by authorized company personnel who can generate reports detailing the information on pending and past customer complaints. These reports are displayed as web pages and indicate the current status of each complaint and the progress in resolving each complaint.

### BRIEF DESCRIPTION OF THE DRAWINGS

FIG. 1 is a block diagram of the basic architecture of a voice-based survey or attitudinal research system used with an embodiment of the present invention;

FIG. 2 is a diagram of an example of a customer database table used with an embodiment of the present invention;

FIG. 3 is a flow diagram describing the initial operation of a voice-based survey or attitudinal research system used with an embodiment of the present invention;

FIG. 4 is a flow diagram describing the operation of the Alert Routine used with an embodiment of the present invention;

FIG. 5 is an example of an alert report displayed on a web page according to an embodiment of the present invention.

FIG. 6 depicts an activity summary web page that may be used with an embodiment of the present invention.

FIG. 7 depicts a RED Alert information web page that may be used with an embodiment of the present invention.

FIG. 8 depicts a Manager Alert information web page that may be used with an embodiment of the present invention.

FIG. 9 depicts a Celebrate Alert information web page that may be used with an embodiment of the present invention

### DETAILED DESCRIPTION OF THE EMBODIMENTS OF THE INVENTION

An embodiment of the present invention may be referred to as a Respondent Evaluated Dissatisfaction (RED) Alert System. The system provides real-time customer feedback information to company employees, such as customer service personnel and managers, enabling them to hear customer feedback messages in the actual voice of the customer. This system allows a business to timely respond to customer complaints or address service or system outages being experienced.

The RED Alert system of an embodiment of the present invention generates an electronic notification message when a customer feedback message is received. Additionally, the system can digitally record customer explanations of problems or reasons for dissatisfaction and provide that information on a real-time basis to company employees and managers so that immediate action can be taken. By digitally recording the customer's feedback message, company employees can hear customers in their own words and emotions. The following description of an embodiment of the invention will refer to these customer feedback messages as “complaints.” However, it is contemplated that these feedback messages may also include positive customer feedback as will be discussed below.

The electronic notification message (an “alert” message) is sent to one or more company employees or mangers when a complaint is received. This electronic message can be sent in the form of an electronic mail (“e-mail”) message, a page, a voice mail message, a facsimile message, or an equivalent type of electronic notification method. All of these methods are effective methods for real-time notification of company employees of complaints. However, the preferred method of sending the “alert” message is by e-mail due to the speed at which an employee or manger will receive the complaint. Furthermore, e-mail messages can be received by a multitude of different devices other than a personal computer. For example, it is common today for e-mail messages to be transmitted to Personal Digital Assistants (PDAs), cellular phones, and alphanumeric pagers. Thus, a company employee can immediately receive an e-mailed notification message regardless of where he or she is located. E-mail messages also allow audio files to be attached to the main message. Voice mail messages also provide the advantage of allowing the attachment of audio files.

The electronic notification message may include a variety of information regarding the customer complaint. Such information may include the date and time the complaint was received, an ID number assigned to the complaint, and a telephone number which the employee can call in order to listen to the customer's recorded complaint. Additionally, the notification message may include a statement about the nature of the complaint and the customer's contact information, possibly including the customer's telephone number.

An audio file may also be attached to the electronic notification message which may be played by the company employee. The audio file would include a spoken message provided by the customer.

Because the customer complaints are all received at a common source, i.e., the RED Alert system, they may all be summarized on a web site which may be accessed by authorized personnel to track the total number of customer complaints, the status of existing complaints, and the time required to respond to those complaints. A more detailed description of the embodiments of the invention will now be described in relation to the Figures.

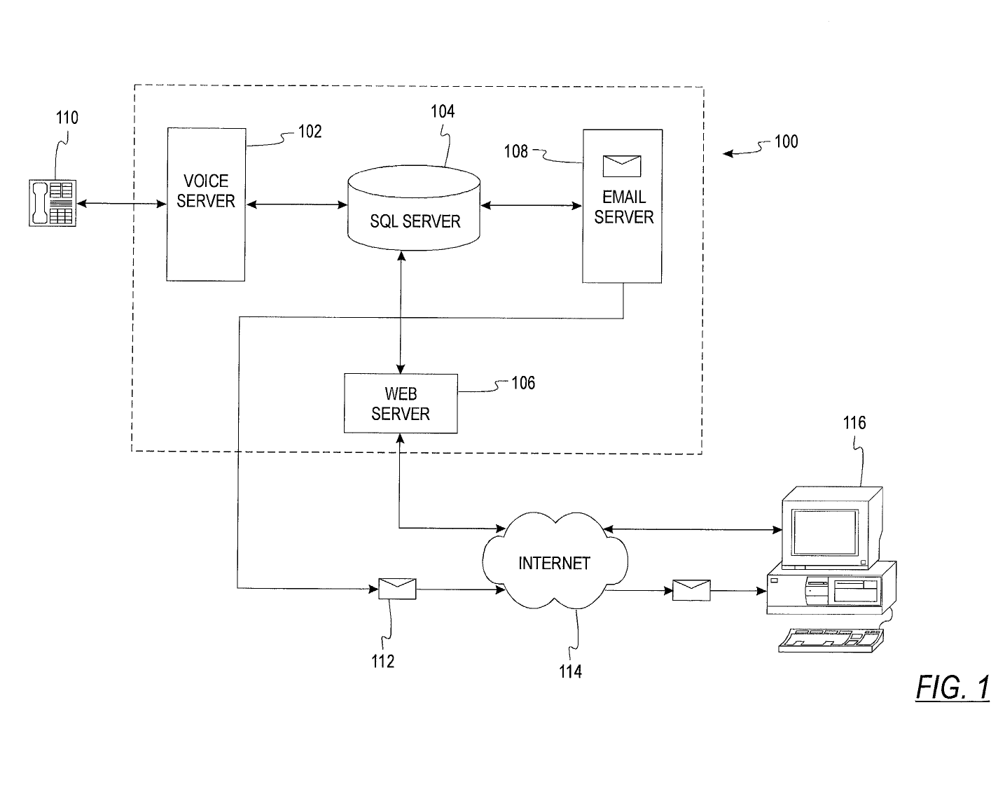

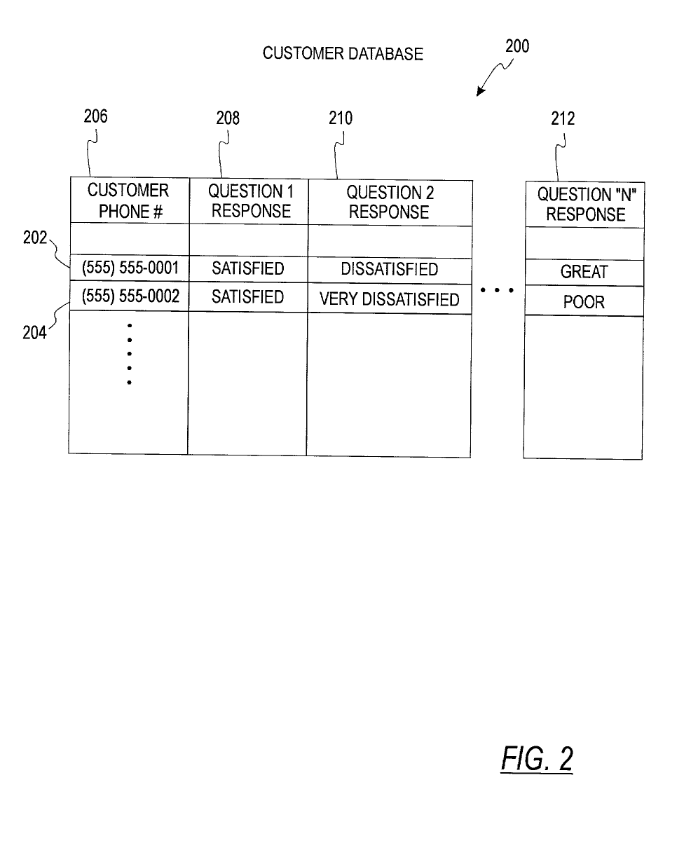

FIG. 1 depicts the basic architecture of a voice-based survey or attitudinal research system used with an embodiment of the present invention in which the electronic notification messages are sent via e-mail. This system 100 is comprised of an a voice server 102, an SQL server 104, a web server 106, and an e-mail server 108. The voice server 102 runs an Interactive Voice Response (IVR) software application that interfaces with customers 110 to obtain customer survey responses. In a preferred embodiment, the voice server 102 uses pre-recorded digital voice prompts in conjunction with OmniVox® a graphical IVR development platform manufactured by Apex Voice Communications, 15250 Ventura Boulevard, Sherman Oaks, Calif. 91403 (www.apexvoice.com). Dialogic® D/240SC-T1 voice processing boards (www.dialogic.corn) are the preferred voice processing boards for use with the voice server 102. Information received from a customer is stored within the SQL server 104 as a record within a database. A preferred type of SQL server is a Microsoft® SQL server. FIG. 2 depicts an example of how the database may be organized. The database 200 contains numerous records 202, 204 which can be modified to include any number of different fields 206, 208, 210, 212 useful in tracking customer complaints. These records 202, 204 may be referred to as complaint records.

The e-mail server 108 is used to transmit notification messages to company personnel. The SQL server 104 transmits the data for the notification message to the e-mail server 108. The e-mail server 108 creates the notification message 112 via the Internet 114 to the appropriate company employee 116. The company employee 116 may also access information stored in the SQL server 104 by logging into the Web server 106.

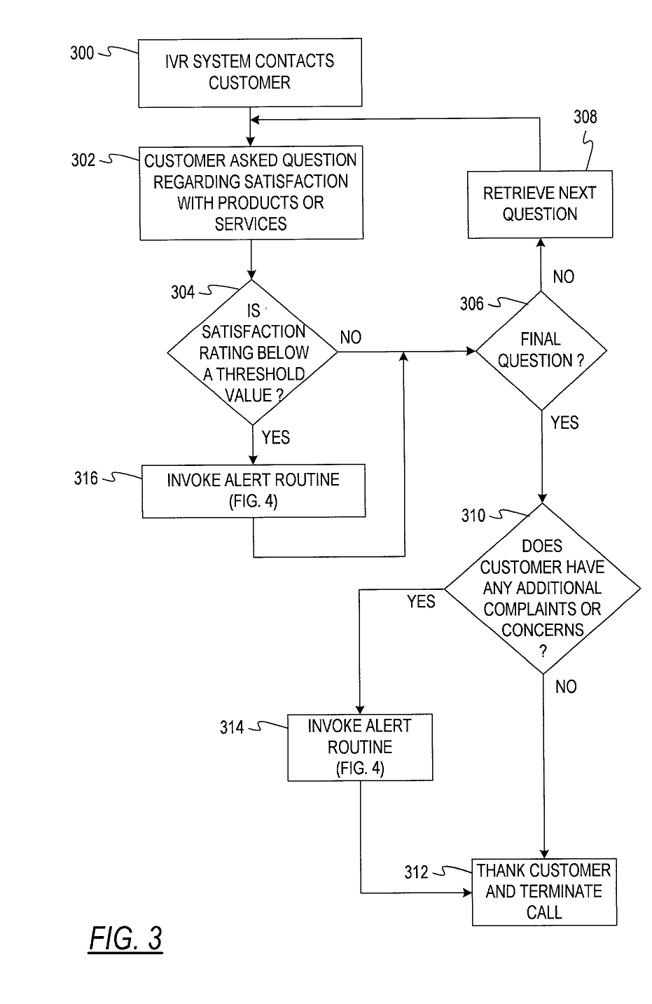

FIG. 3 is a flow diagram describing the operation of a voice-based survey or attitudinal research system used with an embodiment of the present invention. Initially, the IVR system contacts a customer 300. An alternative method is for the customers to initiate contact with the IVR system by calling a toll-free telephone number. Customers are then asked to rate their level of satisfaction regarding services or products they have received from a specified company 302. The customer may provide these ratings using either the touch-tone keys on the telephone or by speaking the rating into the telephone. If the speech recognition method is used, the IVR system must contain a speech recognition software engine. A preferred speech recognition software engine is developed by Nuance Communications of 1380 Willow Road, Menlo Park, Calif. 94025 (www.nuance.com). The customer may rate satisfaction using, for example, a number scale (i.e., 1, 2, 3) or a word scale (i.e., great, satisfactory, poor).

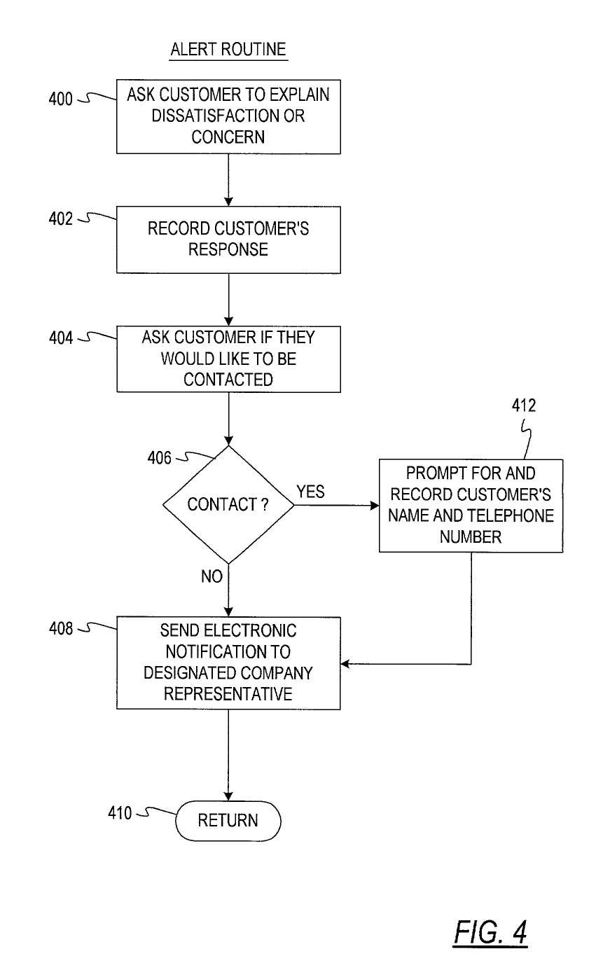

This satisfaction rating is then compared to a threshold value 304. This value may be set by the company or business that is the subject of the survey. If the satisfaction rating is equal to or above the threshold value, then the IVR system checks whether it has reached the final question 306. If the final question has not been reached, the next survey question is retrieved from a question database 308 which is stored in the SQL server 104 on optical or digital media, such as an optical or magnetic disk. The process is repeated beginning at step 302 in FIG. 3. Once the IVR system has reached the final question, the system asks the customer whether he or she has any additional complaints or concerns 310. If the customer has none, then the IVR system thanks the customer for participating in the survey and disconnects the call 312. However, if the customer indicates he or she does have an additional complaint or concern, the Alert Routine is invoked 314 which will be discussed below in relation to FIG. 4.

If the comparison in step 304 determines the customer's rating to be below the threshold value, the Alert Routine is invoked 316. This routine will now be discussed below.

FIG. 4 is a flow diagram describing the operation of the Alert Routine used with an embodiment of the present invention. This routine is initiated whenever a customer indicates a satisfaction level below the acceptable threshold level, thereby indicating a “complaint”, or when the customer indicates he or she has an additional complaint or concern. Upon initiation, the Alert Routine prompts the customer to explain why he or she was dissatisfied or to explain the complaint or concern 400. The Alert Routine then records the customer's response 402, assigns a response ID to the voice file, and stores the voice file in the customer database 200 within the SQL server 104. It is preferred that this recording ultimately be stored in a digital format. The recording can initially be made in a digital format and stored on a magnetic or optical disk. Alternatively, this recording can initially be made in an analog format and then subsequently converted into a digital format. Voice processing boards, such as the Dialogic® D/240SC-T1 (www.dialogic.com), may be used to digitally record customer responses. A preferred method for recording the voice of the customer is to use proprietary technology developed by Alliance Research termed VOCALS® (www.allianceresearch.corn).

When the customer has completed recording their response, the Alert Routine asks whether or not the customer would like to be contacted regarding their dissatisfaction, complaint or concern 404. If the customer responds “no” 406, then an electronic notification of the customer's response (i.e. an “alert” message) is sent to the designated representative of the company that is the subject of the survey 408. Control is then returned to the IVR system in order to ask any remaining survey questions 410. If the customer indicates that he or she would like to be contacted regarding the response, the Alert Routine prompts the customer for his or her name and telephone number 412 which is recorded and stored in the database 200 along with the customer's response.

The customer may be given the option to input his telephone number using either the touch tone keys of his telephone or by speaking his telephone number. The Dialogic D/240SC-T1 voice processing board mentioned above may be used to recognize the Dual Tone Multi-Frequency (DTMF) tones generated by a customer's telephone if the telephone keypad is used to enter the telephone number. A voice recognition software engine, such as that manufactured by Nuance Communications mentioned above, may be used to recognize the telephone number of the customer if he chooses to speak the telephone number.

After all the complaint information has been gathered from the customer, an electronic notification message (an “alert” message) is then sent to the designated company representative 408, such as customer service personnel, and control is passed back to the IVR routine 410.

The electronic notification message is intended to alert appropriate company personnel that a customer has experienced an unacceptable level of dissatisfaction or that a complaint exists. This alert enables appropriate action to be immediately taken to resolve the issue. The electronic notification message may be transmitted as an electronic mail (“e-mail”) message, a page, a voice mail message, a facsimile message, or an equivalent type of electronic notification method. The electronic notification message contains details about the customer complaint. These details may include a response ID number related to the complaint, and a telephone number which may be called in order to listen to the customer complaint. In a preferred embodiment, this telephone number is a toll free number. The company representative may also obtain the name and telephone number of the customer if that information was provided.

Furthermore, if the customer chose to record a message, the digitally recorded message may be attached as an audio file and transmitted along with a compatible electronic notification message. For instance, if a voice mail message is used to alert the company representative, a copy of the customer's recorded message and any name and telephone number information may be attached to the voice mail message.

Customer audio files may also be attached to an e-mail message functioning as the electronic notification message. In such a case, it may be necessary to convert the audio file into a format that is compatible with a Microsoft®Windows®environment so that it may be played on a personal computer using, for example, Windows Media Player. This conversion would be required if the customer's audio file was recorded as a VOX file, which is done by the Dialogic® voice processing boards mentioned above. A VOX audio file contains a digital representation of customer's message sampled at a rate of 3 kilobytes/second. This provides a very small file which is easily stored in the voice server 102 or in database 200 on the SQL server 104. However, this VOX file is not compatible with commonly used software for playing audio files on personal computers, such as Windows Media Player. Most of these software programs require audio files with a sampling rate of at least 11 kilobytes/second. Commercially available software, such Audio Toolbox® manufactured by Voice Information Systems, Inc. (www.voiceinfo.com), can be used to convert the VOX formatted audio file into a WAV formatted audio file which can be played by Windows Media Player or similar software.

Alternatively, a voice-to-text software engine may be used to translate the customer's audio file into a text message. This text message may then be appended to an e-mail notification message or included with a pager message if text paging is available. An example of such voice-to-text software is Dragon NaturallySpeaking® manufactured by Lernout & Hauspie (www.lhsl.corn or www.dragonsys. com).

As discussed, the RED alert system discussed above also maintains a database 200 that tracks all complaints received for a specific company. This database may be accessed by authorized company personnel to monitor the number of complaints received and how the complaints are being handled. The system includes a web server 106 that interfaces with the SQL server 104 to enable authorized personnel to access the database using an Internet connection. To review the information in the database 200, the user accesses a web site associated with the RED alert system. The user is then prompted to enter a login ID and a password. Upon access, the system retrieves all information from the database regarding the company associated with the user's login ID. If the customer surveys were designed to gather information for multiple store locations or subsidiaries of a company, the user will first be presented with a list of store locations from which to choose after logging into the system. The list of store locations presented to a user may be based upon the user's login ID. For instance, if the user is a regional store manager, he would be presented with only a list of stores in his region. Upon selecting a location or subsidiary, the system will retrieve all customer complaint information related to the selected store location or subsidiary.

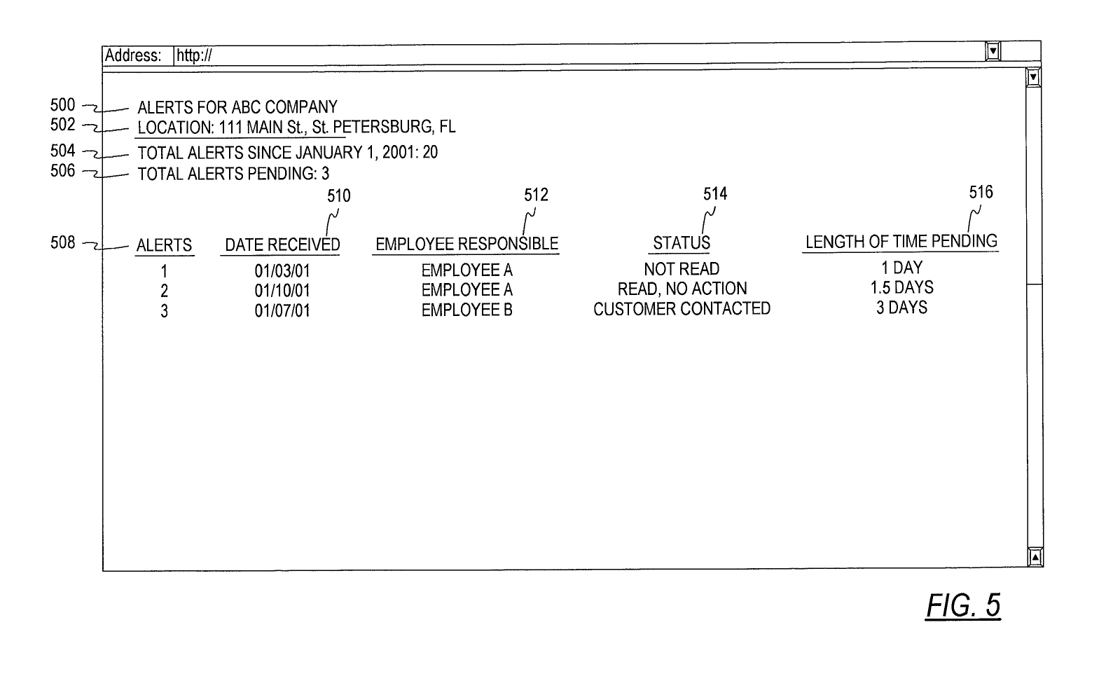

FIG. 5 is an example of the type of information that a user may view from the web site. The alert report web page generated from the web site indicates the company name 500 and the selected store location or subsidiary 502 if appropriate. The total number of alerts for the selected store location or subsidiary generated from customer complaints is also displayed 504. The user may specify a date parameter limiting the time period considered for displaying the total number of alerts. The example in FIG. 5 indicates the user has selected to calculate the total number of alerts generated since Jan. 1, 2001. The web page also displays the total number of pending alerts, that is, those which have not yet been resolved 506.

A detailed display of each pending alert is also provided which includes information relevant to each alert. The information displayed can be customized for each company using the system. The detailed display for each alert 508 in FIG. 5 includes the date the customer complaint was received 510 (which is the same day the alert was transmitted), the employee responsible for responding to the alert 512, the current status 514, and the length of time the alert has been pending 516. Additional fields may be added to this display depending upon the requirements of the surveying company. For instance, if an audio file has been recorded containing a spoken customer complaint, a link to this file may also be displayed (for example, a hyperlink may be used if HTML coding is used). By selecting this link, the employee could listen to the audio file.

The alert reports generated and displayed on the web pages enables company managers to easily determine how quickly employees are responding to customer complaints and dissatisfaction. Also, the reports enable managers to identify those store locations or subsidiaries that are experiencing high levels of customer complaints or dissatisfaction.

The fields displayed in the web page report may be updated automatically by the system itself or may be updated by authorized company employees. For instance, “Employee Responsible” field 512 may be automatically populated with the employee name who received the electronic notification of the customer complaint. This field may later be updated by an authorized employee if a different employee becomes responsible for resolving the alert. The “Status” field 514 may be automatically updated if the electronic notification is transmitted by voice mail, e-mail, or via a two-way pager. These methods of notification allow the system to track whether or not a notification message has been read. Once the message has been read, the system can update the “Status”. Authorized personnel may also manually update the “Status” field 514.

Once the “Status” of an alert is marked as “completed”, it is removed from the list of pending alerts. The alert information is maintained in a “history” portion of the database containing the company's alert information. This information can later be accessed to generate additional reports regarding complaint and dissatisfaction report histories.

An alternative embodiment of the present invention may implement several different categories of notification messages depending upon how certain survey questions are answered. A “first level” notification message may be sent only to a store manager if a customer indicates dissatisfaction in response to a minor question or with a specific service or experience at a specific store. This “first level” notification message may be termed a “Manager Alert” and may be generated if a customer indicates dissatisfaction to questions such as “How satisfied were you with the taste of the French Fries?” or “How would you rate the cleanliness of the rest rooms?”

A “second level” notification message may be generated if a customer indicates dissatisfaction in response to a major question. For instance, if a customer indicates dissatisfaction to the question, “How would you rate your overall experience at our store?”, then a second level notification message would be generated. This message would be sent to both a store manager and a district manager. This second level notification message may be termed an actual “RED Alert” since it indicates a heightened level of customer dissatisfaction and may require intervention by a district manager.

A third level notification message may be used to notify store managers and district managers when positive feedback is received from a customer. For instance, if a customer responds that his overall experience at the store was “excellent”, then a third level notification message would be generated. These messages may be termed “Celebrate Alerts” because they indicate when a store is performing at a level that meets or exceeds customer expectations.

A first, second, or third level notification message may also be generated depending upon the satisfaction rating given by a customer in response to any question. For instance, if a customer rates his satisfaction as “poor” in response to the question, “How satisfied were you with the taste of the French Fries?”, then a first level notification message would be generated. However, if the customer rates his satisfaction as “very poor” in response to the same question, then a second level notification would be generated. A third level notification message or “Celebrate Alert” would be generated if the customer provided a response of “excellent.”

In accordance with this embodiment, any number of additional notification messages could be generated depending upon customer responses to questions. Notification messages may be sent to personnel responsible for particular areas in which a customer has indicated a level of dissatisfaction below the acceptable threshold level. For instance, notification messages may be sent to building maintenance personnel or personnel responsible for buying food from suppliers.

A problem may arise with the use of the third level notification message or “Celebrate Alert” discussed above. False surveys may be completed by personnel of a particular store in order to improve the store's overall satisfaction scores. An embodiment of the present invention attempts to identify these false surveys by tracking the telephone number from where each survey is completed. This can be done using the Automatic Number Identification (ANI) feature provided by the telephone network. The system then tracks the number of surveys completed by each telephone number. If multiple surveys have been completed from a single telephone number within a short period of time, for example within a 2-4 week time period, it is likely that these are false surveys.

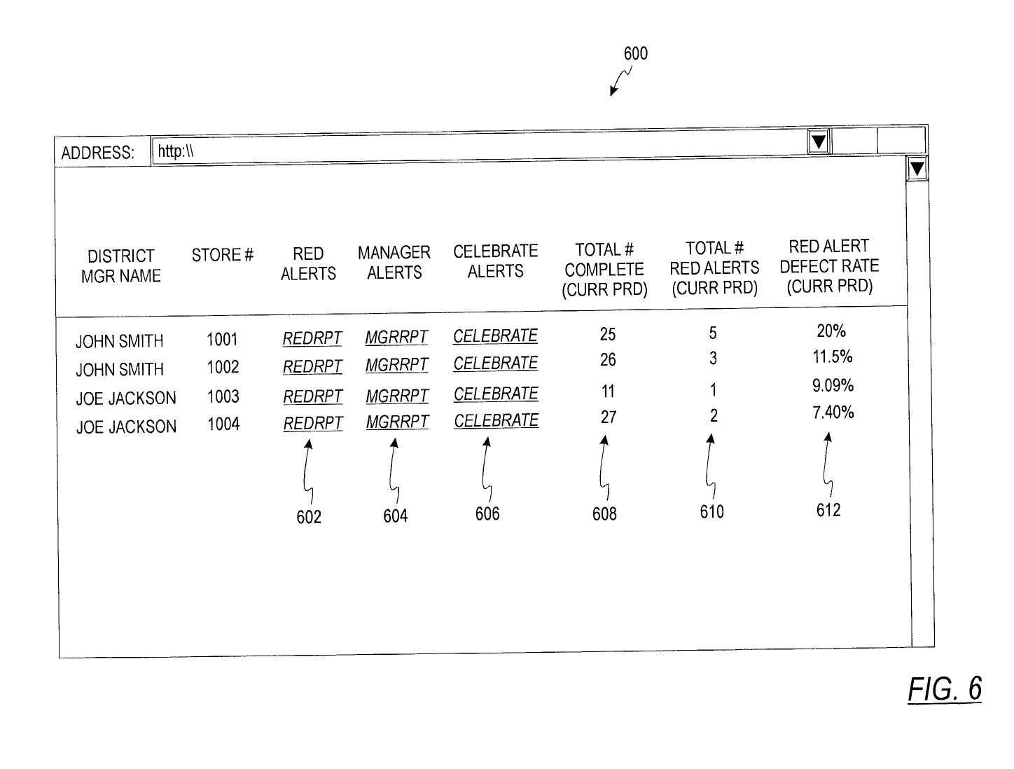

FIG. 6 depicts an alternative web page 600 that may be used to track and access information gathered by the RED alert system. Once a user logs into the RED alert system, a summary page similar to that shown in FIG. 6 may be displayed. If the user has selected to use different categories of notification messages as discussed above, hyperlinks may appear displayed on the summary page to enable the user to access more detailed information about each of the different categories. The summary page in FIG. 6 provides hyperlinks to additional web pages that provide information related to “RED Alerts” 602, “Manager Alerts” 604, and “Celebrate Alerts” 606 as discussed above. The summary page 600 can be customized to provide any other type of summary information the user desires. For example, the summary page may indicate the total number of surveys completed for the current period for a particular store 608, the total number or RED alerts generated for that store during the current period 610, and the RED alert defect rate for the current period for a particular store 612. This value is calculated as the total number of RED alerts for a particular store divided by the total number of completed surveys for that store. Additional information such as total number of Manger alerts or Celebrate alerts for the current period could also be displayed, as well as, defect rates or the number of alerts generated for past periods.

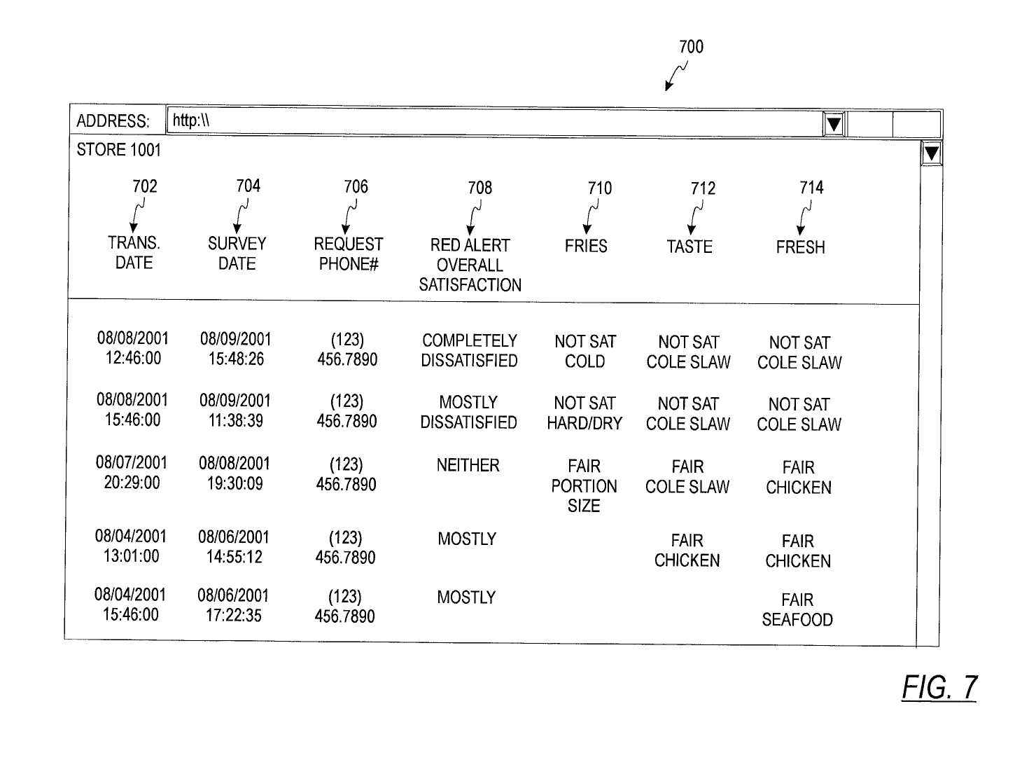

FIG. 7 depicts a RED Alert information page 700 which may be displayed if a user selects the “RedRpt” hyperlink 602 in FIG. 6 for store 1001. Again, the information displayed on this page can be customized according to the needs of the user. The example shown in FIG. 7 displays the customer transaction date and time 702, the date and time of the telephonic survey 704, the customer's telephone number 706, the “overall satisfaction” rating 708 which caused the Red alert to be generated, and the answers given by the customer in response to various questions 710, 712, 714.

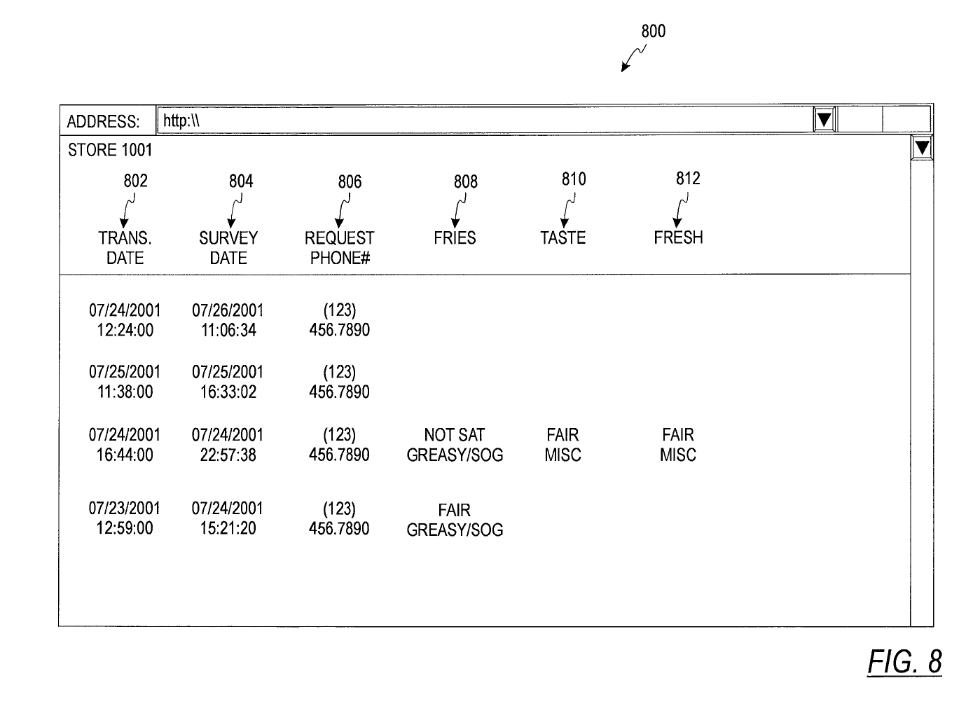

FIG. 8 depicts a Manager Alert information page 800 which may be displayed if a user selects the “MgrRpt” hyperlink 604 in FIG. 6 for store 1001. The information displayed on this page can be customized according to the needs of the user. The example shown in FIG. 8 displays the customer transaction date and time 802, the date and time of the telephonic survey 804, the customer's telephone number 806, and the answers given by the customer in response to various questions 808, 810, 812.

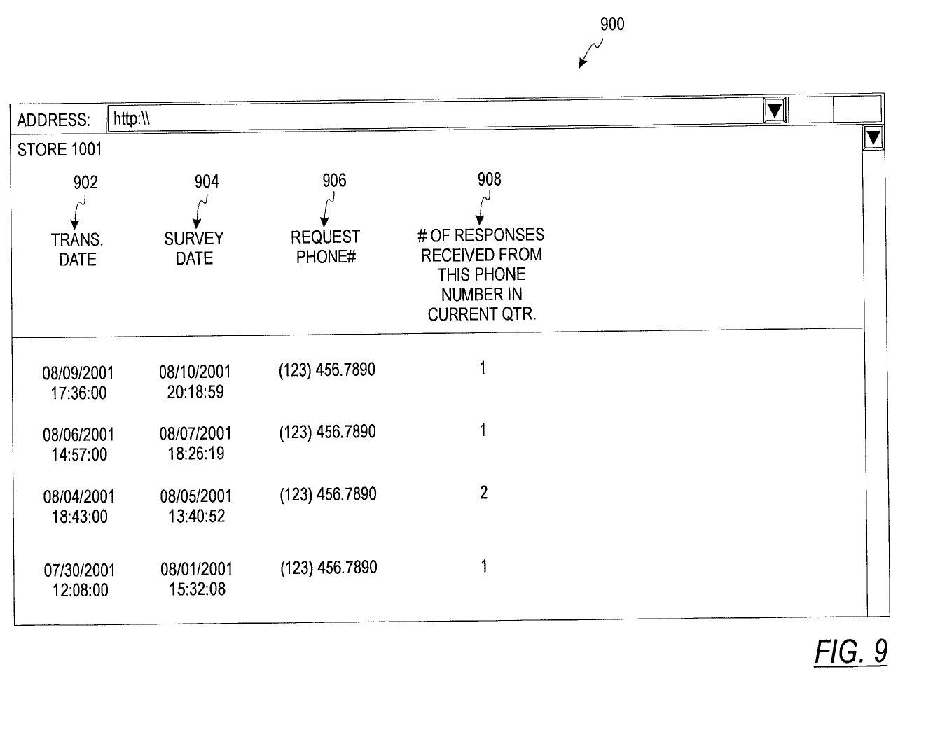

Finally, FIG. 9 depicts a Celebrate Alert information page 900 which may be displayed if a user selects the “Celebrate” hyperlink 606 in FIG. 6 for store 1001. The information displayed on this page can be customized according to the needs of the user. The example shown in FIG. 9 displays the customer transaction date and time 902, the date and time of the telephonic survey 904, the customer's telephone number 906, and the total number of responses received from the specified phone number during the current quarter 908. This last field is used to monitor for false survey responses as discussed above. The period over which multiple responses are counted could be varied as desired, the use of a quarterly basis is merely an example.

The descriptions of the embodiments described above are set forth for illustrative purposes and are not intended to limit the present invention in any manner. Equivalent approaches are intended to be included within the scope of the present invention. While the present invention has been described with reference to the particular embodiments illustrated, those skilled in the art will recognize that many changes and variations may be made thereto without departing from the spirit and scope of the present invention. These embodiments and obvious variations thereof are contemplated as falling within the scope and spirit of the claimed invention.

We claim:

1. A method for notifying personnel of customer feedback messages, comprising the steps of:
receiving a customer feedback message;
storing said feedback message in a database;
creating an electronic notification message containing information about said feedback message; and
transmitting said notification message to an employee.

2. The method of claim 1 wherein said notification message is an e-mail message.

3. The method of claim 1 wherein said step of receiving said feedback message includes receiving a customer satisfaction rating.

4. The method of claim 3 wherein said information in said notification message includes said customer satisfaction rating.

5. The method of claim 3 comprising the further steps of:
determining whether said customer satisfaction rating is below a threshold value; and
transmitting a second electronic notification message to a second employee if said customer satisfaction rating is below said threshold value.

6. The method of claim 3 comprising the further steps of:
determining whether said customer satisfaction rating is above threshold value; and
transmitting a third electronic notification message to said employee if said customer satisfaction rating is above said threshold value.

7. The method of claim 1 comprising the further steps of:
creating an audio file containing said feedback message; and
attaching said audio file to said notification message.

8. A method for notifying personnel of customer feedback messages, comprising the steps of:
receiving a spoken customer feedback message;
creating an audio file containing a recording of said spoken feedback message;
storing said audio file in a database;
generating an electronic notification message, said notification message indicating that said feedback message has been received;
transmitting said electronic notification message to an employee; and
accessing said database and playing said audio file to said employee upon receiving a command from said employee.

9. The method of claim 8 wherein said notification message is an e-mail message.

10. The method of claim 8 comprising the further step of assigning a response ID to said complaint.

11. The method of claim 10 wherein said command from said employee is said response ID.

12. The method of claim 8 comprising the further steps of:
receiving a satisfaction rating from said customer;
determining whether said satisfaction rating is below a threshold value; and
transmitting a second electronic notification message to a second employee if said satisfaction rating is below said threshold value.

13. The method of claim 8 comprising the further steps of:
receiving a satisfaction rating from said customer;
determining whether said satisfaction rating is above a threshold value; and
transmitting a third electronic notification message to said employee if said satisfaction rating is above said threshold value.

14. The method of claim 12 wherein said second electronic notification message is an e-mail message.

15. A method for notifying personnel of customer messages, comprising the steps of:
receiving a satisfaction rating from a customer;
receiving a spoken message from said customer;
creating an audio file containing a recording of said spoken message;
storing said audio file in a database;
generating an electronic notification message;
attaching said audio file to said notification message;
transmitting said electronic notification message to an employee;
determining whether said satisfaction rating is below a threshold value; and
transmitting a second electronic notification message to a second employee if said satisfaction rating is below said threshold value.

16. The method of claim 15 wherein said second electronic notification message is an e-mail message.

17. A customer feedback notification system, comprising:
a database for storing a customer feedback message;
an electronic notification message, said notification message indicating that said feedback message has been received; and,
a computer server for transmitting said notification message to an employee.

18. The system of claim 17 wherein said electronic notification message is an e-mail message.

19. The system of claim 17 further comprising:
a voice server that receives a spoken message from a customer;
an audio file containing said spoken message, said audio file being generated by said voice server;
wherein said audio file is attached to said notification message before being transmitted to said employee.

20. A customer feedback notification system, comprising:
a voice server for receiving a spoken customer feedback message;
a database for storing said feedback message in an audio file;
an electronic notification message indicating that said feedback message has been received and including said audio file as an attachment; and
a computer server for transmitting said notification message to an employee.

21. The system of claim 20 wherein said electronic notification message is an e-mail message.

22. A method for receiving and tracking customer feedback messages, comprising the steps of:
receiving a customer feedback message;
storing said feedback message in a database;
creating an electronic notification message indicating that said feedback message has been received;
transmitting said notification message to an employee;
accessing said database using a web server to retrieve said feedback message; and
displaying said feedback message within a web page to said employee.

23. The method of claim 22 wherein said notification message is an e-mail message.

24. The method of claim 22 wherein said step of receiving said feedback message includes receiving a customer satisfaction rating.

25. The method of claim 24 wherein said information in said notification message includes said customer satisfaction rating.

26. The method of claim 24 comprising the further steps of:
determining whether said customer satisfaction rating is below a threshold value; and
transmitting a second electronic notification message to a second employee if said customer satisfaction rating is below said threshold value.

27. The method of claim 22 comprising the further steps of:
creating an audio file containing said customer feedback message;
storing said audio file in said database; and
providing a link on said web page enabling said employee to playback said audio file.

28. A system for receiving and tracking customer complaints, comprising:
a voice server for receiving a customer complaint;
a database for storing said complaint in a complaint record;
an electronic notification message indicating that said complaint has been received;
a computer server for transmitting said notification message to an employee;
a web server connected with said database, said web server configured to enable said employee to access said database to retrieve said compliant record; and
a web page defined to display said complaint record retrieved by said employee.

29. The system of claim 28 wherein said notification message is an e-mail message.

30. The system of claim 28 further comprising:
an audio file containing a spoken customer complaint;
wherein said complaint record includes said audio file.

31. The system of claim 30 wherein said audio file is attached to said notification message.
